(19) United States
(12) Patent Application Publication
(10) Pub. No.: US 2026/0037758 A1
(43) Pub. Date: Feb. 5, 2026

(54) USING ARTIFICIAL INTELLIGENCE AS A SMART ASSISTANT FOR AUDIO VISUAL DEVICES

(71) Applicant: Sony Group Corporation, Tokyo (JP)

(72) Inventors: James R. Milne, Ramona, CA (US); Justin Kenefick, Poway, CA (US); William Clay, San Diego, CA (US); Marvin DeMerchant, San Diego, CA (US)

(73) Assignee: Sony Group Corporation, Tokyo (JP)

(21) Appl. No.: 18/791,153

(22) Filed: Jul. 31, 2024

(51) Int. Cl. G06K 7/14; G06N 5/04

(52) U.S. Cl. CPC G06K 7/1417; G06K 7/1413; G06N 5/04

(57) ABSTRACT

A media application determines a first unique identifier associated with a first media device in a media system. The media application receives an installation request for instructions for installing the first media device. The media application provides the first unique identifier as input to a machine-learning model. The machine-learning model outputs first installation instructions. Responsive to receiving one or more subsequent unique identifiers associated with one or more subsequent media devices in the media system, the media application provides the first unique identifier, the one or more subsequent unique identifiers, and the installation request as input to a machine-learning model. The machine-learning model outputs one or more subsequent installation instructions that include a description of how to connect the one or more subsequent media devices to the first media device.

### BACKGROUND

As hardware gets increasingly complicated, users struggle with properly connecting devices using the right cables, connecting the devices to a network, ensuring compatibility between devices, troubleshooting issues, etc. A user can read a manual associated with the device, but the manual is often unhelpful. Furthermore, problems may exist that the manufacturer is not yet aware of and, as a result, has not provided a solution.

### SUMMARY

A computer-implemented method includes determining a first unique identifier associated with a first media device in a media system. The method further includes receiving an installation request for instructions for installing the first media device. The method further includes providing the first unique identifier as input to a machine-learning model. The method further includes outputting, with the machine-learning model, first installation instructions. The method further includes responsive to receiving one or more subsequent unique identifiers associated with one or more subsequent media devices in the media system and the installation request, providing the first unique identifier, the one or more subsequent unique identifiers, and the installation request as input to the machine-learning model. The method further includes outputting, with the machine-learning model, one or more subsequent installation instructions that include a description of how to connect the one or more subsequent media devices to the first media device.

In some embodiments, the machine-learning model includes a query engine and a large language model, and the method further includes providing the first unique identifier, the one or more subsequent unique identifiers, and the installation request to the query engine; combining the first unique identifier, the one or more subsequent unique identifiers, and the installation request with a template to form a query; and providing the query as input to the large language model, wherein the large language model outputs the first installation instructions that correspond to the query. In some embodiments, combining the first unique identifier, the one or more subsequent unique identifiers, and the installation request with the template further includes specifying a prioritization of one or more data sources that are used by the large language model to output the installation instructions. In some embodiments, the method further includes monitoring the media system to identify information about a performance of the media system; providing the first unique identifier, the one or more subsequent unique identifiers, and information about the performance of the media system to the machine-learning model as input; and outputting, with the machine-learning model, an identification of a performance issue associated with the media system and a description of a solution to the performance issue. In some embodiments, the performance issue is associated with the first media device and the method further includes determining that the solution to the performance issue fails; and contacting a chatbot associated with a manufacturer of the first media device to obtain an additional solution.

In some embodiments, the method further includes receiving a request for information about the first media device; providing first unique identifier, the request for information, and information about the performance of the media system to the machine-learning model; and outputting, with the machine-learning model, the information about the first media device. In some embodiments, the method further includes receiving feedback about whether the first installation instructions were successful; and providing the feedback to the machine-learning model. In some embodiments, the feedback is selected from a group of a confirmation from a user that the first installation instructions worked, an inference that the first installation instructions worked based on the first media device connecting to a network, and combinations thereof. In some embodiments, outputting the first installation instructions includes generating a diagram of the first media device and the one or more subsequent media devices in the media system. In some embodiments, determining the first unique identifier associated with the first media device is based on one action selected from a group of: scanning a barcode or a QR code, receiving a Request For Information (RFI), receiving a Near Field Communication (NFC), receiving a manufacturer name and a model number, scanning a page that includes purchasing information, receiving the first unique identifier from a mobile device, and combinations thereof.

A system comprises one or more processors and logic encoded in one or more non-transitory media for execution by the one or more processors and when executed are operable to: determine a first unique identifier associated with a first media device in a media system; receive an installation request for instructions for installing the first media device; provide the first unique identifier as input to a machine-learning model; output, with the machine-learning model, first installation instructions; responsive to receiving one or more subsequent unique identifiers associated with one or more subsequent media devices in the media system, provide the first unique identifier, the one or more subsequent unique identifiers, and the installation request as input to a machine-learning model; and output, with the machine-learning model, one or more subsequent installation instructions that include a description of how to connect the one or more subsequent media devices to the first media device.

In some embodiments, the machine-learning model includes a query engine and a large language model and the logic is further operable to: provide the first unique identifier, the one or more subsequent unique identifiers, and the installation request to the query engine; combine the first unique identifier, the one or more subsequent unique identifiers, and the installation request with a template to form a query; and provide the query as input to the large language model, wherein the large language model outputs the first installation instructions that correspond to the query. In some embodiments, combining the first unique identifier, the one or more subsequent unique identifiers, and the installation request with the template further includes specifying a prioritization of one or more data sources that are used by the large language model to output the installation instructions. In some embodiments, the logic is further operable to: monitor the media system to identify information about a performance of the media system; provide the first unique identifier, the one or more subsequent unique identifiers, and information about the performance of the media system to the machine-learning model as input; and output, with the machine-learning model, an identification of a performance issue associated with the media system and a description of a solution to the performance issue. In some embodiments, the performance issue is associated with the first media device and the software is further operable to: determine that the solution to the performance issue fails; and contact a chatbot associated with a manufacturer of the first media device to obtain an additional solution.

Software encoded in one or more non-transitory computer-readable media for execution by one or more processors and when executed is operable to: determine a first unique identifier associated with a first media device in a media system; receive an installation request for instructions for installing the first media device; provide the first unique identifier as input to a machine-learning model; output, with the machine-learning model, first installation instructions; responsive to receiving one or more subsequent unique identifiers associated with one or more subsequent media devices in the media system, provide the first unique identifier, the one or more subsequent unique identifiers, and the installation request as input to a machine-learning model; and output, with the machine-learning model, one or more subsequent installation instructions that include a description of how to connect the one or more subsequent media devices to the first media device.

In some embodiments, the machine-learning model includes a query engine and a large language model and the software is further operable to: provide the first unique identifier, the one or more subsequent unique identifiers, and the installation request to the query engine; combine the first unique identifier, the one or more subsequent unique identifiers, and the installation request with a template to form a query; and provide the query as input to the large language model, wherein the large language model outputs the first installation instructions that correspond to the query. In some embodiments, combining the first unique identifier, the one or more subsequent unique identifiers, and the installation request with the template further includes specifying a prioritization of one or more data sources that are used by the large language model to output the installation instructions. In some embodiments, the software is further operable to: monitor the media system to identify information about a performance of the media system; provide the first unique identifier, the one or more subsequent unique identifiers, and information about the performance of the media system to the machine-learning model as input; and output, with the machine-learning model, an identification of a performance issue associated with the media system and a description of a solution to the performance issue. In some embodiments, the performance issue is associated with the first media device and the software is further operable to: determine that the solution to the performance issue fails; and contact a chatbot associated with a manufacturer of the first media device to obtain an additional solution.

A further understanding of the nature and the advantages of particular embodiments disclosed herein may be realized by reference of the remaining portions of the specification and the attached drawings.

### BRIEF DESCRIPTION OF THE DRAWINGS

FIG. 1 is a block diagram of an example network environment according to some embodiments described herein.

FIG. 2 is a block diagram of an example computing device according to some embodiments described herein.

FIG. 3 illustrates example user interfaces for scanning a unique identifier associated with a media device, associating the media device with a name, and providing options for different types of information according to some embodiments described herein.

FIG. 4A illustrates an example user interface that includes information about performance of a media device according to some embodiments described herein.

FIG. 4B illustrates an example user interface that includes information about performance of a cable according to some embodiments described herein.

FIG. 4C illustrates an example user interface that includes installation instructions for connecting a sound bar to a television according to some embodiments described herein.

FIG. 5 illustrates an example architecture of a machine-learning model that satisfies requests from a user according to some embodiments described herein.

FIGS. 6A-6B include a flowchart of an example method to use a machine-learning model to provide installation instructions, a solution to a performance issue, and information about a media device according to some embodiments described herein.

FIG. 7 is a flowchart of an example method to train a machine-learning model to provide installation instructions according to some embodiments described herein.

FIG. 8 is a flowchart of an example method to use a machine-learning model to provide installation instructions according to some embodiments described herein.

### DETAILED DESCRIPTION OF EMBODIMENTS

The technology described below advantageously solves the problem of how to install media devices, troubleshoot problems with media devices, and obtain information about media devices. A media application receives an installation request from a user and a unique identifier associated with the media device. For example, the media application may generate a user interface that includes an option for scanning a QR code or a barcode, receive an NFC communication or an RFI package, receive an image of a receipt for a purchase of the media device, etc. The media application provides the installation request and the unique identifier to a machine-learning model that outputs installation instructions.

In some embodiments, the installation request includes a query engine that combines the installation request and the unique identifier into a template that is provided to a large language model (LLM). The LLM may be trained using training data that includes media device manuals from manufacturers, information from forums associated with the manufacturers, information from forums that are confirmed to be reliable, etc. The LLM outputs the installation instructions.

In some embodiments, the LLM outputs installation instructions that include images of how a media device attaches to a media system. In some embodiments, a user may provide a name for the media device that is included in the images from the installation instructions to help with connecting a new media device or a replacement media device to a preexisting media system.

The media application also identifies a performance issue associated with the media device. The media application may identify the performance issue based on monitoring information, such as network access and speeds received by the media device, or based on a user identifying the performance issue. The media application provides the unique identifier and information about the performance issue to the machine-learning model. The machine-learning model outputs a description of a solution to the performance issue. For example, the solution may include steps taken by the media application to resolve the issue, an identification of a cable that needs to be moved to a different port, etc.

The media application may receive a request from a user for information about a media device. The machine-learning model receives the unique identifier and information about the media system and outputs information about the media device.

The media application advantageously identifies accurate information about media devices that is customized to help a particular user with technical difficulties, such as obtaining accurate information for adding a new media device to a media system, troubleshooting problems with a media system, proactively identifying problems, suggesting optimization of the media system, and/or providing information about the media system to the user.

### Example Environment 100

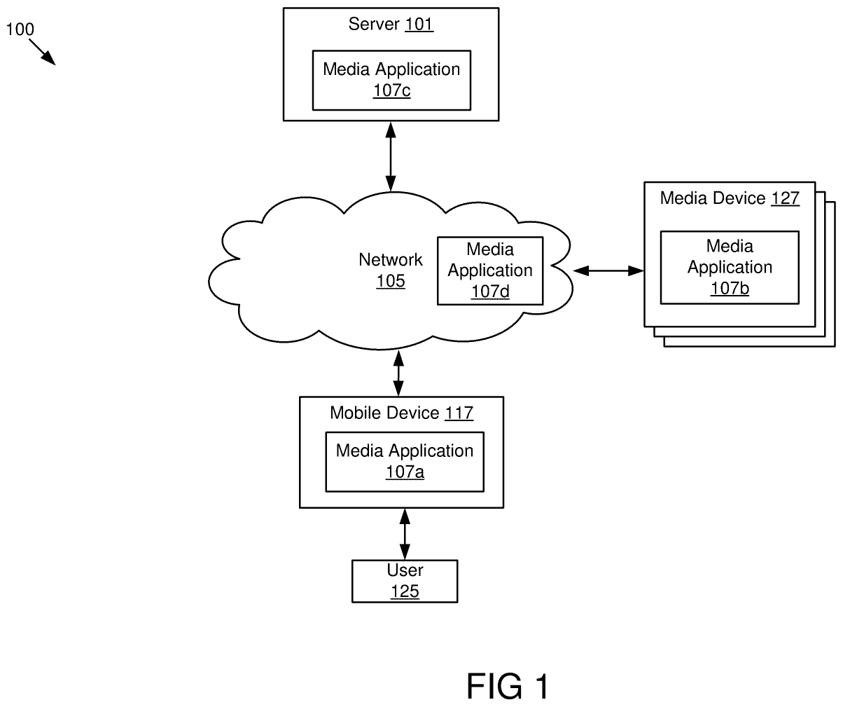

FIG. 1 illustrates a block diagram of an example environment 100. In some embodiments, the environment 100 includes one or more mobile devices 117, media devices 127, and a server 101. In some embodiments, the environment 100 may include other servers or devices not shown in FIG. 1. In FIG. 1 and the remaining figures, a letter after a reference number, e.g., “107a,” represents a reference to the element having that particular reference number (e.g., a media application 107a stored on the mobile device 117). A reference number in the text without a following letter, e.g., “107,” represents a general reference to embodiments of the element bearing that reference number (e.g., any media application 107).

The mobile device 117 is a computing device that includes a memory, a hardware processor, and a media application 107 (e.g., media application 107a). The mobile device 117 may include a smartphone, a tablet computer, a laptop, a mobile telephone, a wearable device, a head-mounted display, a mobile email device, or another electronic device capable of accessing a network 105 to communicate with one or more of the media device 127, the wireless device 120, and the server 101. The mobile device 117 is associated with a user 125.

The mobile device 117 may be coupled to the network 105 wirelessly using Wi-Fi®, Bluetooth®, or other wireless technology. The mobile device 117 is used by way of example. While FIG. 1 illustrates one mobile device 117, the disclosure applies to a system architecture having one or more mobile devices 117.

The mobile device 117 includes a display. For example, if the mobile device 117 is a smartphone, the smartphone may include a touch-sensitive display that displays a user interface for a user. The user interface may display options for answering a registration questionnaire, providing feedback on recommendations, etc.

The media application 107a includes logic that is operable to generate a user interface that includes a registration questionnaire and that receives answers to the registration questionnaire. The registration questionnaire may ask the user 125 to provide a username and password, information about media devices 127, and a name for each media device 127. In some embodiments, the media application 107a generates a user interface for the user 125 to provide requests for information, such as installation instructions, solutions to performance issues, information about a particular media device 127, etc.

The media device 127 includes a processor, a memory, a speaker, a display, and network communication hardware. The media device 127 may be a television, a video player, a virtual reality (VR) headset, an augmented reality (AR) headset, a DVD player, an audio/video receiver, a speaker, a sound bar, etc. The set of media devices is referred to as a media system.

The media device 127 may connect to the network 105 through a wired connection, such as Ethernet, coaxial cable, fiber-optic cable, etc., or a wireless connection, such as Wi-Fi®, Bluetooth®, or other wireless technology.

The media device 127 includes a media application 107b. In some embodiments, the media application 107b receives a request from the mobile device 117 or directly via a user interface generated on the media device 127. The media application 107b may provide the request and one or more unique identifiers corresponding to one or more media devices 127 to a machine-learning model. In some embodiments, the media application 107b also receives network information from a media application 107d stored on the network 105. For example, the media application 107d may provide connection speeds, a history of connection speeds, etc. The machine-learning model outputs information related to the request, such as installation instructions for a media device 127, a description of a solution to a performance issue, information about the media device 127, etc.

The server 101 includes a processor, a memory, and network communication hardware. In some embodiments, the server 101 is a hardware server. The server 101 is communicatively coupled to the network 105 via a wired connection, such as Ethernet, coaxial cable, fiber-optic cable, etc., or a wireless connection, such as Wi-Fi®, Bluetooth®, or other wireless technology. In some embodiments, the server 101 includes a media application 107c. In some embodiments and with user consent, the media application 107c on the server 101 maintains a copy of user profiles, training data for a machine-learning model, etc.

In some embodiments, the media application 107c on the server 101 includes the trained machine-learning model and provides information to the media device 127 to take advantage of greater processing power provided by the server 101.

### Example Computing Device 200

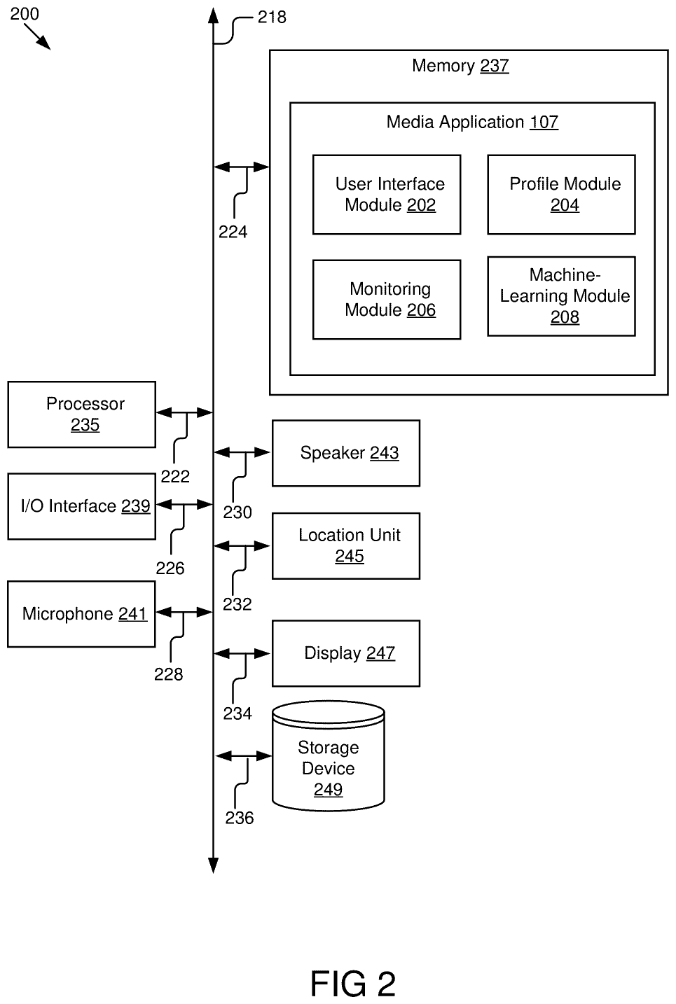

FIG. 2 is a block diagram of an example computing device 200 that may be used to implement one or more features described herein. The computing device 200 can be any suitable computer system or other electronic or hardware device. In some embodiments, the computing device 200 is the media device 127 in FIG. 1. In some embodiments, the computing device 200 is the mobile device 117 in FIG. 1. In some embodiments, some portions of the computing device 200 are performed by one or more of the media device 127, the mobile device 117, and/or the server 101 in FIG. 1.

In some embodiments, computing device 200 includes a processor 235, a memory 237, an Input/Output (I/O) interface 239, a microphone 241, a speaker 243, a location unit 245, a display 247, and a storage device 249. The processor 235 may be coupled to a bus 218 via signal line 222, the memory 237 may be coupled to the bus 218 via signal line 224, the I/O interface 239 may be coupled to the bus 218 via signal line 226, the microphone 241 may be coupled to the bus 218 via signal line 228, the speaker 243 may be coupled to the bus 218 via signal line 230, the location unit 245 may be coupled to the bus 218 via signal line 232, the display 247 may be coupled to the bus 218 via signal line 234, and the storage device 249 may be coupled to the bus 218 via signal line 236.

The processor 235 can be one or more processors and/or processing circuits to execute program code and control basic operations of the computing device 200. A processor includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, or other systems. A computer may be any processor in communication with a memory.

The memory 237 is typically provided in computing device 200 for access by the processor 235 and may be any suitable processor-readable storage medium, such as random access memory (RAM), read-only memory (ROM), Electrical Erasable Read-only Memory (EEPROM), Flash memory, etc., suitable for storing instructions for execution by the processor or sets of processors, and located separate from processor 235 and/or integrated therewith. Memory 237 can store software operating on the computing device 200 by the processor 235, including the media application 107.

The I/O interface 239 can provide functions to enable interfacing the computing device 200 with other systems and devices. Interfaced devices can be included as part of the computing device 200 or can be separate and communicate with the computing device 200. For example, network communication devices, storage devices (e.g., the memory 237 or the storage device 249), and I/O devices can communicate via the I/O interface 239.

In some embodiments, the I/O interface 239 handles communication between the computing device 200 and other devices in a network (e.g., the mobile device 117, the server 101, the wireless device 120, the media device 127, etc.) via a wireless protocol, such as Wi-Fi®, Bluetooth®, Near Field Communication (NFC), Radio Frequency Identification (RFID), Ultra-Wideband (UWB), Request for Information (RFI), infrared, etc.

The microphone 241 includes hardware for detecting sounds. For example, the microphone 241 may detect people speaking. The speaker 243 produces an audio signal that is heard by the user.

The location unit 245 includes hardware to identify a current location of the computing device 200. The location unit 253 includes one or more of a global positioning system (GPS), Bluetooth®, Wi-Fi®, NFC, RFID, UWB, RFI, and infrared.

The display 247 may connect to the I/O interface 239 to display content, e.g., a user interface, and to receive touch (or gesture) input from a user. The display 247 can include any suitable display device such as a liquid crystal display (LCD), light emitting diode (LED), or plasma display screen, television, monitor, touchscreen, or other visual display device.

The storage device 249 stores data related to the media application 107. For example, the storage device 249 may store user profiles generated by the media application 107, training data for a machine-learning model, etc.

Although particular components of the computing device 200 are illustrated, other components may be added or removed.

### Example Media Application 107

The media application 107 includes a user interface module 202, a profile module 204, a monitoring module 206, and a machine-learning module 208. Different modules may be stored on different types of computing devices. For example, a first computing device 200 may be a mobile device 117 that includes the user interface module 202 and a profile module 204, and a second computing device 200 may be a media device 127 that includes the monitoring module 206 and the machine-learning module 208.

The user interface module 202 generates graphical data for displaying a user interface. In some embodiments, a user downloads the media application 107 onto a mobile device 117 or uses the media application 107 stored on a media device 127, such as a television. The user interface module 202 may generate graphical data for displaying a user interface with a registration questionnaire where the answers are received by the profile module 204 and used to generate a corresponding user profile. The user interface may be displayed on a mobile device 117 or a media device 127.

The registration questionnaire may ask the user 125 to provide a username and password. In some embodiments, the registration questionnaire also asks for device information about devices associated with a user, such as media devices 127 that are part of a media system. In some embodiments, the user 125 provides information about the media devices 127 by scanning a barcode or a QR code, receiving an RFI, receiving an NFC, receiving a manufacturer name and a model number, scanning a page that includes purchasing information, receiving audio from a user that includes a serial number, etc. The profile module 204 receives the user input and uses the user input to generate a profile for the user.

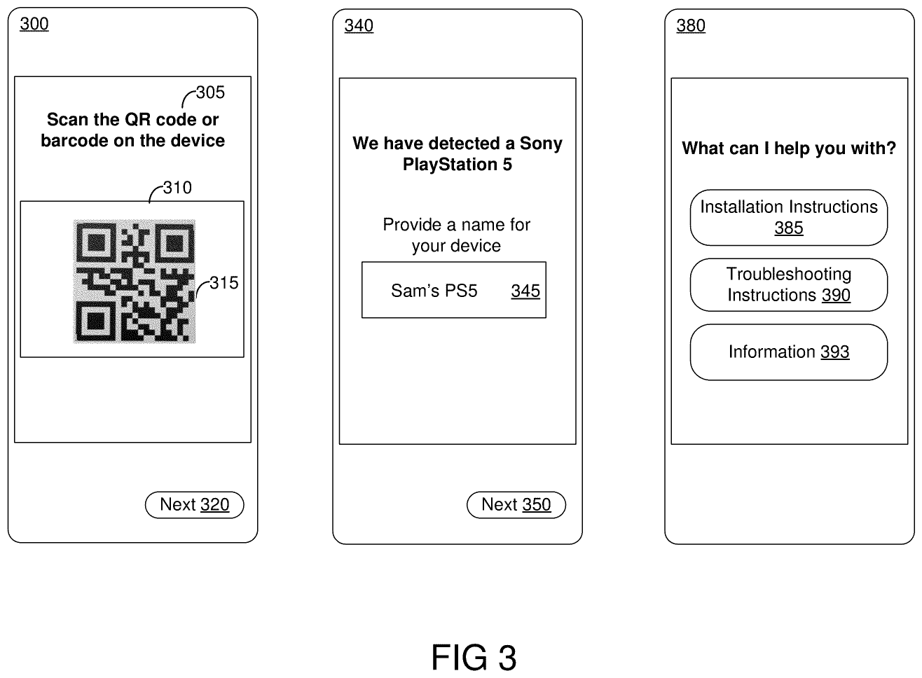

FIG. 3 illustrates an example first user interface 300 for scanning a unique identifier associated with a media device according to some embodiments. The first user interface 300 includes instructions 305 for how to capture a QR code or barcode through the viewfinder 310 (e.g., “Scan the QR code or barcode on the device”). In this example, a user aims a mobile device 117 at a QR code 315. The mobile device 117 may automatically capture an image of the QR code 315 once the QR code 315 is identifiable or once the user selects the next button 320.

The user interface module 202 determines a unique identifier associated with a media device 127 based on the information provided by the user. For example, the user interface module 202 may determine the unique identifier based on a QR code, a barcode, a serial number entered manually into a user interface, an image of information, such as a page that includes purchasing information, etc. In some embodiments, the user interface module 202 receives, via a wireless protocol, information about the media device 127. For example, the user interface module 202 may receive an RFI, an NFC, a Bluetooth communication, etc. where the packet includes the unique identifier associated with the media device 127. The unique identifier is used by the machine-learning module 208 to identify the name of the media device 127, the manufacturer, the model number, the serial number, the year it was built, or any other information needed to satisfy a request.

In some embodiments, the user interface module 202 generates a user interface with information about the media device 127 associated with the unique identifier. FIG. 3 illustrates an example second user interface 340 that associates the media device 127 with a name according to some embodiments described herein. In FIG. 3, the second user interface 340 includes an option to name the media device 127 in the text field 345. In this example, the user has input “Sam's PS5,” which refers to a type of gaming console into the text field 345.

In some embodiments, the user interface module 202 generates a user interface that includes options for a user to select for different types of information. For example, the options may be prepopulated and include a request for providing installation instructions, a request for providing a solution to a performance issue, a request for optimization suggestions, a request for information about a particular media device 127, etc. In some embodiments, instead of pressing a button the user interface module 202 includes a button for a user to provide audio with instructions for different kinds of information. Other options are possible, such as text fields where a user may provide a request, a drop-down box, etc. The user interface may be displayed on a mobile device 117 or a media device 127, such as a television.

FIG. 3 illustrates an example third user interface 380 that provides options for different types of information according to some embodiments described herein. In this example, the user interface 380 includes an installation instructions button 385, a troubleshooting instructions button 390, and an information button 393. In some embodiments, selecting one of the buttons 385, 390, 393 results in additional questions being asked. For example, if a user selects the installation instructions button 393, the user interface may ask for confirmation that the user is installing a particular device. In another example, if the user selects the troubleshooting instructions button 390, the user interface may ask for details about what problems the user is experiencing. In yet another example, if the user selects the information button 393, the user interface may provide popular subject areas that may be related to information that the user is seeking.

The user interface module 202 receives an installation request for installation instructions for a media device 127. The user interface module 202 determines a unique identifier associated with the media device 127. For example, the user interface module 202 may generate a user interface that helps a user scan a QR code or barcode that is on the media device 127. In this example, the unique identifier is associated with a Sony PlayStation 5.

As described in greater detail below, the monitoring module 206 monitors the media devices 127. For example, the monitoring module 206 may identify a decrease in bandwidth from an internet provider. In some embodiments, the user interface module 202 generates a user interface that includes information about the performance issue. The user interface may be displayed on a mobile device 117 or a media device 127.

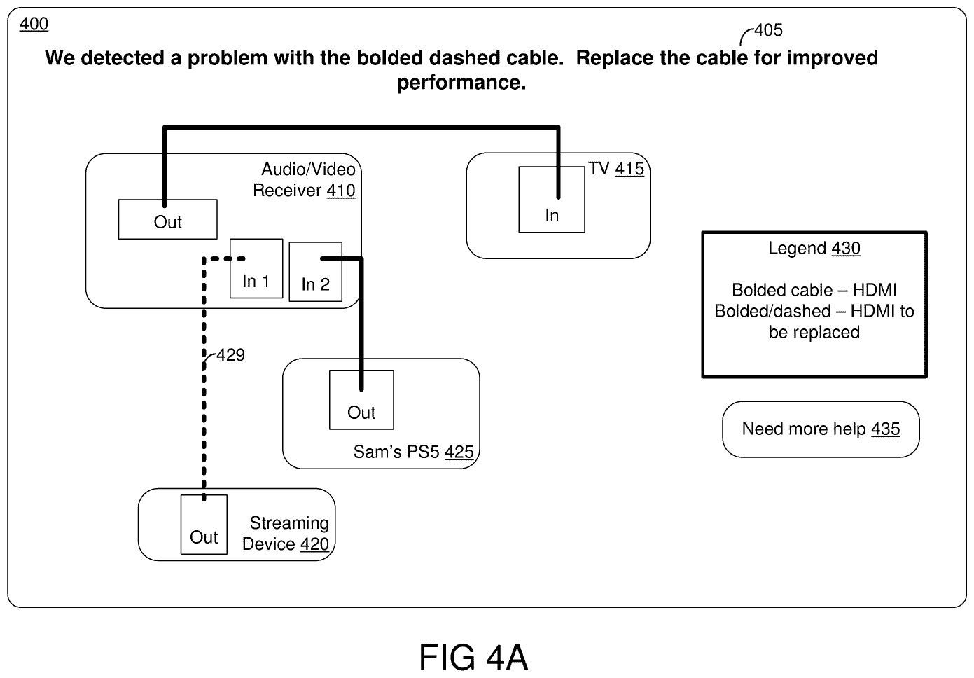

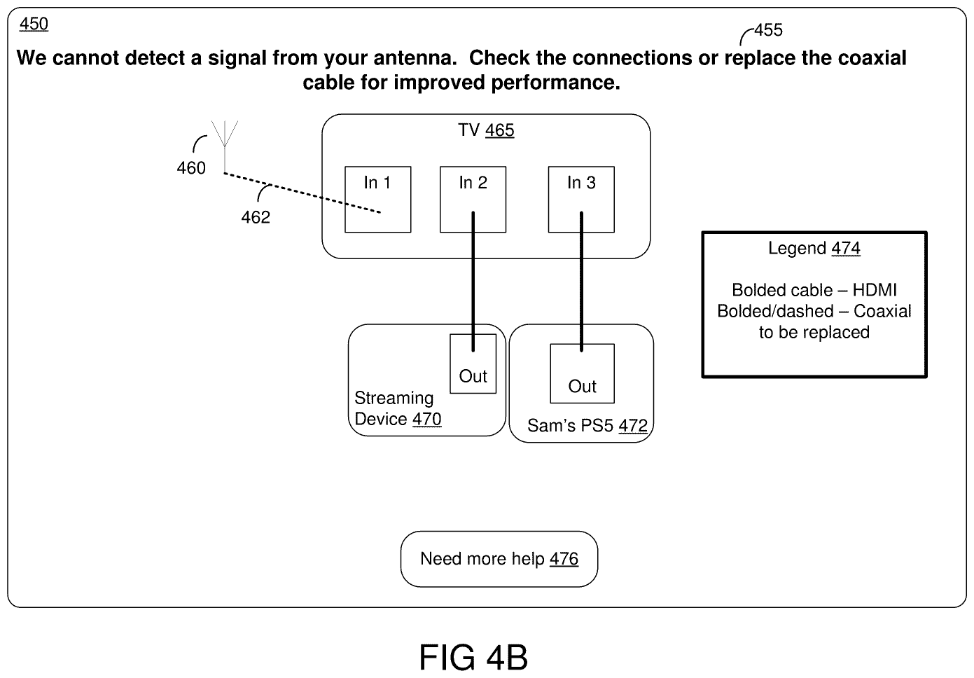

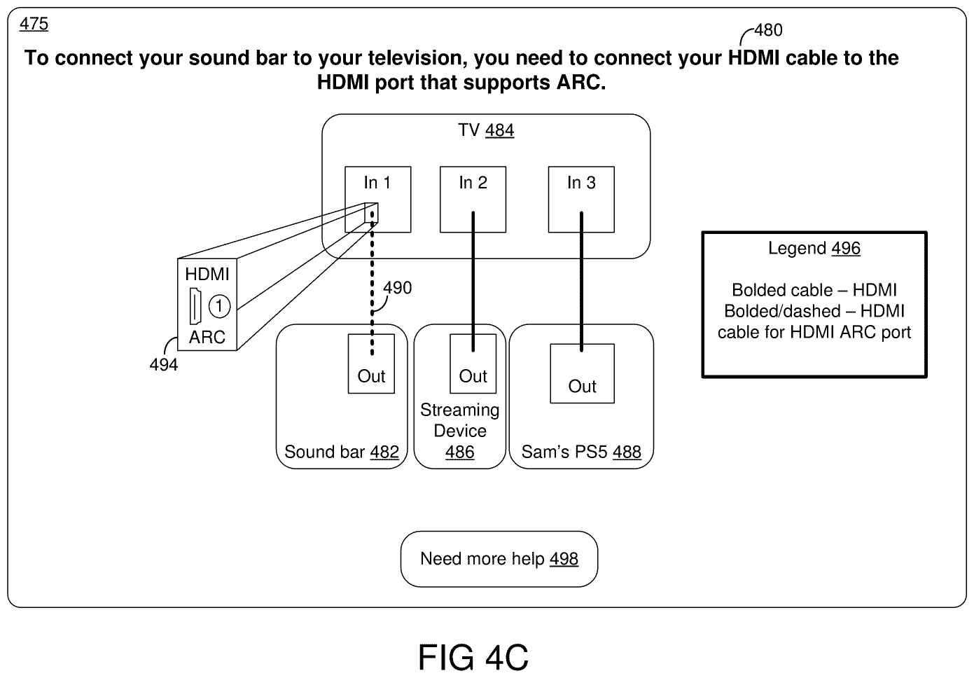

FIG. 4A illustrates an example user interface 400 that includes information about performance of a media device according to some embodiments described herein. In this example, the audio of the media system is prioritized. The user interface 400 includes text 405 that identifies a problem with the media system (e.g., “We detected a problem with the bolded dashed cable. Replace the cable for improved performance.”).

The user interface 400 includes a system diagram of four media devices 127: an audio/video receiver 410, a television 415, a streaming device 420, and Sam's PS5 425. The gaming console identified using the user's name for the gaming console (i.e., Sam's PS5). The system diagram illustrates the various cables that attach the media devices 127 to each other and identifies an HDMI cable 429 to be replaced as identified by the machine-learning module 208. The user interface 400 also includes a legend 430 that describes cables illustrated in the system diagram. The user interface 400 includes a “need more help” button 435 that a user may press to obtain additional guidance.

FIG. 4B illustrates an example user interface 450 that includes information about performance of a cable according to some embodiments described herein. In this example, the video of the media system is prioritized. The user interface 450 includes text 455 that identifies a problem with the media system (e.g., “We cannot detect a signal from your antenna. Check the connections or replace the coaxial cable for improved performance.”).

The user interface 450 includes a system diagram of four media devices 127: an antenna 460, a television 465, a streaming device 470, and Sam's PS5 472. The system illustrates the various cables that attach the media devices 127 to each other and identifies a coaxial cable 462 to be checked and possibly replaced as identified by the machine-learning module 208. The user interface 400 also includes a legend 474 that describes cables illustrated in the system diagram. The user interface 450 includes a “need more help” button 476 that a user may press to obtain additional guidance.

FIG. 4C illustrates an example user interface 475 that includes installation instructions for connecting a sound bar 482 to a television 484 according to some embodiments described herein. The user interface 475 includes text 480 that identifies how to connect the HDMI cable 490 from the sound bar 482 to the television 484. Specifically, the HDMI cable for the sound bar 482 needs to attach to the HDMI port that includes an Audio Return Channel (ARC) or an enhanced ARC (eARC). The user interface 475 includes a magnified illustration of the HDMI ARC port 494 to help guide the user to look for the correct port. This detail is important because without a port that supports ARC, the sound bar 482 will not work. The magnified illustration of the HDMI port 494 also includes an illustration that this is the first HDMI input as highlighted by the circle with 1 in the center.

The user interface 475 includes the streaming device 486, Sam's PS5 488, and a legend 496 to help the user understand the location of the different media devices 127 in the media system. The user may select the need more help button 498 to obtain additional guidance, such as a video that shows how a user would connect the HDMI cable to the HDMI ARC port.

In some embodiments, the user interface module 202 generates a user interface that includes a section on user preferences. The user preferences may include options for how a user prefers to view monitoring information. For example, the user may not want to receive solutions to problems and optimizations unless requested; the user may want to receive solutions and optimizations but during breaks, pauses, and while switching between content options; or the user may want to receive a notification anytime a solution or an optimization is available.

The profile module 204 receives answers to the questionnaire created by the user interface module 202 that includes the username and password, device information, etc. The profile module 204 generates a user profile for the user that provided the answers. In some embodiments, the profile module 204 updates the profile each time the profile module 204 receives a unique identifier associated with a media device 127 from the user interface module 128.

The monitoring module 206 monitors the media devices 127 and identifies information about a performance associated with the media devices 127. In some embodiments, the monitoring module 206 performs diagnostic tests periodically. For example, the monitoring module 206 may ping the network 105 for a network connection speed and determine whether the network connection speed is affected by jitter, latency, or packet loss. The machine-learning module 208 may identify whether jitter, latency, and packet loss are caused by network congestion, hardware issues, or a failure to implement packet prioritization. For example, the monitoring module 206 may ping each media device 127 to determine network connection download speeds and upload speeds, which the machine-learning module 208 may use to identify whether the issue arises from hardware issues. In another example, the machine-learning module 208 may identify the efficacy of a network mesh. In some embodiments, the monitoring module 206 monitors audio quality to identify a bitrate or sample rate of the audio. In some embodiments, the monitoring module 206 monitors video quality, such as the video resolution and/or the video frame rate.

In some embodiments, the monitoring module 206 uses a port sniffer to monitor, for each media device 127, which ports are open and which ports are connected. The machine-learning module 208 uses the information about ports to identify which port a new device could be connected to, identify possible issues with cables based on a lag in data transmission, etc.

The monitoring module 206 provides the information about the performance of the media devices 127 to the machine-learning module 208. The machine-learning module 208 uses the information about the performance of the media devices 127 to identify performance issues and to provide information to a user responsive to receive a request for the information.

In some embodiments, the monitoring module 206 provides information about the performance associated with the media device to the machine-learning module 208 in response to a user identifying a problem with a media device 127 and/or the user requesting information about the media device 127.

The machine-learning module 208 trains a machine-learning model to receive a unique identifier associated with a media device 127 and output installation instructions. The machine-learning module 208 trains the machine-learning model to receive one or more unique identifiers associated with one or more media devices 127 and information about the performance of the one or more media devices 127 and output an identification of a performance issue associated with the first media device and a description of a solution to the performance issue. In some embodiments, the machine-learning module 208 is further trained to output optimization information about one or more media devices 127 and/or information about the one or more media devices 127.

In some embodiments, the machine-learning module 208 trains the machine-learning model using different data sources. The training data includes manuals associated with each media device 127 as provided by the manufacturer. The training data also includes online forums, such as forums associated with the manufacturer, expert forums, or crowd-sourced forums. In some embodiments, the training data is weighted based on a reliability of different training data sources and instances where solutions described in online forums were identified as being successful.

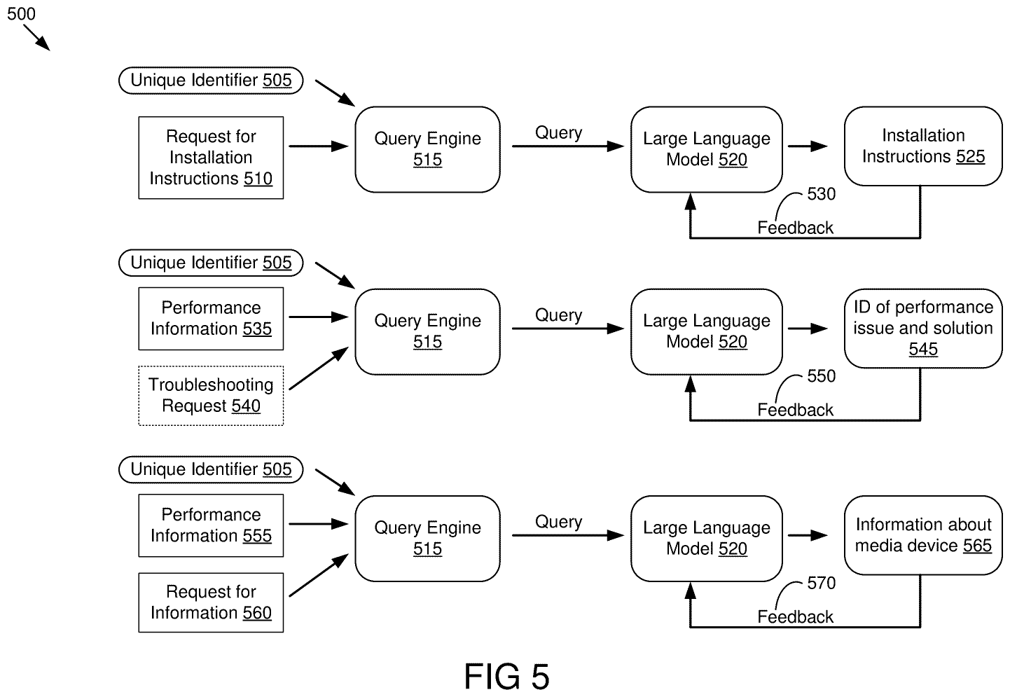

FIG. 5 illustrates an example architecture 500 of a machine-learning model that satisfies requests from a user according to some embodiments described herein. The architecture 500 includes a query engine 515 that receives input information and generates a query. In some embodiments, the query engine 515 is a machine-learning model, such as a text-to-text transformer that processes natural language queries by combining different types of information into a template to form a query. The query is provided as input to a large language model 520. The large language model 520 outputs results based on the query.

In a first example illustrated in FIG. 5, the query engine 515 receives a unique identifier 505 associated with a media device 127 and a request for installation instructions 510. The query engine 515 combines the first unique identifier 505, the request for installation instructions 510, and a template to form a query. For example, for a media system with a single media device 127 the query may include: “Your task is to provide <installation instructions> that correspond to <unique identifier>.” If the media system includes multiple media devices 127, the query may include: “Your task is to provide <installation instructions> that correspond to <first unique identifier> when it is connected to <second unique identifier> and <third unique identifier>.”

The large language model 520 outputs installation instructions 525 that correspond to the query. In some embodiments, the template further includes a request for the large language model 520 to output a diagram of components of the media system. The diagram may include names for each of the media devices that were named by a user. In some embodiments, the large language model 520 receives feedback 530 based on the installation instructions 525. For example, the feedback 530 may include a user stating that the installation instructions 525 did not make sense, that the user needs more detail about one of the steps in the installation instructions, etc. The feedback 530 may also include an inference that the installation instructions 525 worked based on the media device 127 connecting to the network. The machine-learning module 208 performs fine tuning of the large language model 520 responsive to receiving the feedback 530.

In some embodiments, the template further includes a request for the large language model 520 to output a video. The video may illustrate different steps, such as how a user would connect a media device 127 to another media device 127 using a particular type of cable.

In a second example illustrated in FIG. 5, the query engine 515 receives the unique identifier 505 associated with a media device 127, performance information 535 received from the monitoring module 206, and an optional troubleshooting request 540. The query engine 515 combines the first unique identifier 505, the performance information 535, the optional troubleshooting request 540, and a template to form a query. The performance information 555 may include information that is associated with a performance issue, such as network upload speeds, network download speeds, connected ports, open ports, an error log, etc.

Situations where the troubleshooting request 540 is not part of the template may include generating the query responsive to periodically receiving the performance information 535 from the monitoring module 206 to determine if a performance issue exists. For example, the monitoring module 206 may provide performance information 555 that identifies that the video quality is reduced, which appears as more blocky objects on a display screen. The query engine 515 may generate a query that states: “Your task is to determine if a performance issue exists for <unique identifier> based on <performance information>. If a performance issue exists, provide <identification of the performance issue and a solution to the performance issue>.” In another embodiments, the query engine 515 may use the performance information 555 to generate a query for how to optimize performance of a media system.

The machine-learning module 208 may add the troubleshooting request 540 as input responsive to receiving a troubleshooting request 540 from a user. The troubleshooting request 540 includes an identification of a particular issue. For example, a user may state: “Why am I still getting sound drops in the rear speaker?”. The query engine 515 may generate a query that takes the form of: “Your task is to determine a solution to <troubleshooting request> for <unique identifier> based on <performance information>. Provide <identification of the performance issue and a solution to the performance issue>.” In this instance, the query may include: “Your task is to determine a solution to why sound drops occur in the rear speaker where the rear speaker is identified by <unique identifier> based on <performance information>.”

In another example, the user may ask why the sound doesn't work when the user plays a video on the television. Because an issue with playing sound may originate with an audio/video device or the television, the query engine 515 may generate a query with multiple unique identifiers and multiple sets of performance information.

The large language model 520 outputs an identification of a performance issue and a solution 545 that corresponds to the query. Continuing with the example of sound drops in the rear speaker above, the large language model 520 may output a solution to change the Wi-Fi channel. In some embodiments, the machine-learning module 208 performs the solution without input from the user. In instances where the output is not responsive to a troubleshooting request 540, but instead part of a monitoring function, the large language model 520 may notify a user of the problem or an optimization available during a less intrusive time, such as a display on a television after the user pauses a video or as part of a suggestion component of a user interface. The identification of the performance issue and the solution 545 may be performed anticipatorily to warn the user that a problem exists that may get worse, such as a signal integrity issue caused by an internet service provider (ISP) where the solution is to wait for the ISP to correct the issue.

In some embodiments, the large language model 520 receives feedback 550 based on the identifier of the performance issue and the solution 545. For example, a user may provide feedback 550 that the identifier of the performance issue is wrong, that the identifier of the performance issue was correct but that the solution did not work, etc. The feedback 550 may also include an inference that the solution worked based on receiving performance information 535 from the monitoring module 206 indicating that the problem was resolved. For example, if the issue was a network connectivity issue and the transmission speeds subsequently improved, the feedback 550 may include the inference that the solution worked. In some embodiments, the machine-learning module 208 transmits a message to a developer of software or a manufacturer when the solution was not identified in a manual.

The machine-learning module 208 performs fine tuning of the large language model 520 responsive to receiving the feedback 550. For example, the large language model 520 may rank a solution that is known to work based on the feedback 550 higher than an untested solution. Conversely, the large language model 520 may associate a lower weight with an unsuccessful solution than a successful solution or an untested solution.

In some embodiments, if the feedback 550 is that the solution to the performance issue did not work, the machine-learning module 208 transmits a notification to a manufacturer of the media device 127 or a software developer associated with a software issue that the solution to the performance issue failed. The machine-learning module 208 may contact a chatbot associated with the manufacturer/software developer to obtain an additional solution. If the manufacturer/software developer provides the additional solution, the machine-learning module 208 updates the machine-learning model to include the additional solution and provides the additional solution to the user.

In a third example illustrated in FIG. 5, the query engine 515 receives the unique identifier 505 associated with a media device 127, performance information 555 received from the monitoring module 206, and a request for information 560. The performance information 555 may include all information associated with the media device 127 corresponding to the unique identifier 505. For example, the performance information 555 may include network upload speeds, network download speeds, connected ports, open ports, bitrates, audio quality, video quality, etc.

The large language model 520 outputs information about the media device 565 that corresponds to the query. In some embodiments, the large language model 520 receives feedback 570 based on the information about the media device 565. For example, a user may provide feedback 570 that the information was incomplete, the user has an additional question, etc. The machine-learning module 208 performs fine tuning of the large language model 520 responsive to receiving the feedback 570.

Large language models are built on natural language text. The query engine 515 and/or the large language model 520 may include learnable weights that are attached to a model layer. The learnable weights may use key and query in self-attention layers of the large language model 520. The loss function may be a cross-entropy loss function for maximizing the likelihood of a desired system response. In some embodiments, the query engine 515 and/or the large language model 520 are fine-tuned by adjusting hyperparameters, such as the number of epochs to train the model for, the batch size (i.e., the number of examples used in a single training pass), the learning rate at which the model weights are updated, and how much the model learns from prompt tokens versus completion tokens.

### Example Methods

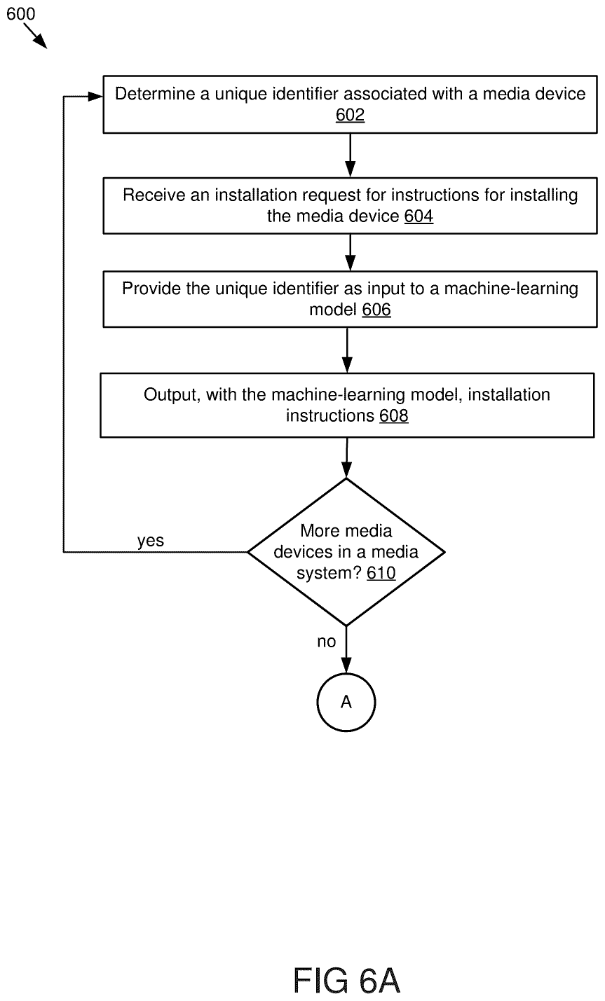

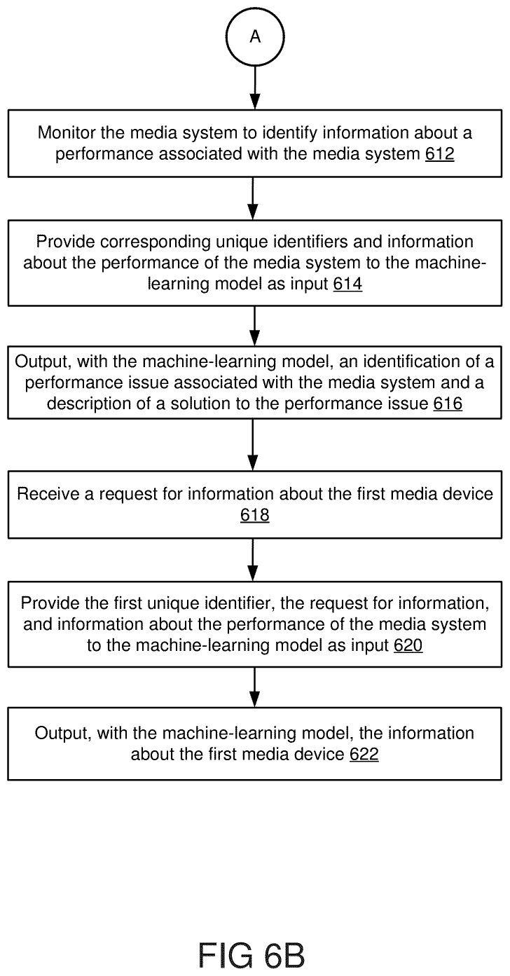

FIGS. 6A-6B include a flowchart of an example method 600 to use a machine-learning model to provide installation instructions, a solution to a performance issue, and information about a media device. The method 600 is implemented by one or more computing devices 200 as described with reference to FIG. 2. The one or more computing devices 200 include the auditory device 135, the mobile device 117, and/or the server 101 as illustrated in FIG. 1.

The method 600 may start with block 602. At block 602, a unique identifier associated with a media device is determined. Block 602 may be followed by block 604.

At block 604, an installation request for instructions for installing the media device is received. Block 604 may be followed by block 606.

At block 606, the unique identifier is provided as input to a machine-learning model. Block 606 may be followed by block 608.

At block 608, the machine-learning model outputs installation instructions. Block 608 may be followed by block 610.

At block 610 it is determined whether there are more media devices in a media system. For example, a second unique identifier may be received. If there are more media devices in the media system, block 610 may be followed by block 602 and the method 600 may continue in a loop until there are no more media devices in the media system, at which point block 610 may be followed by block 612.

At block 612, the media system is monitored to identify information about a performance associated with the media system. Block 612 may be followed by block 614.

At block 614, corresponding unique identifiers and information about the performance of the media system are provided to the machine-learning model as input. In some embodiments, block 614 is triggered by a troubleshooting request provided by the user. Block 614 may be followed by block 616.

At block 616, the machine-learning model outputs an identification of a performance issue associated with the media system and a description of a solution to the performance issue. For example, the performance issue may be that a cable from a first media device to a second media device is not working, a Wi-Fi channel may be sub-optimal, an ISP may have an issue with network connectivity, etc. The solution may include a diagram that illustrates the components of the media system and how to replace hardware, an update that the machine-learning model changed the Wi-Fi channel, an update that the machine-learning model reported an outage to the ISP, etc. Block 616 may be followed by block 618.

At block 618, a request is received for information about the first media device. Block 618 may be followed by block 620.

At block 620, the first unique identifier, the request for information, and information about the performance of the media system is provided as input to the machine-learning model. Block 620 may be followed by block 622.

At block 622, the machine-learning model outputs the information about the first media device.

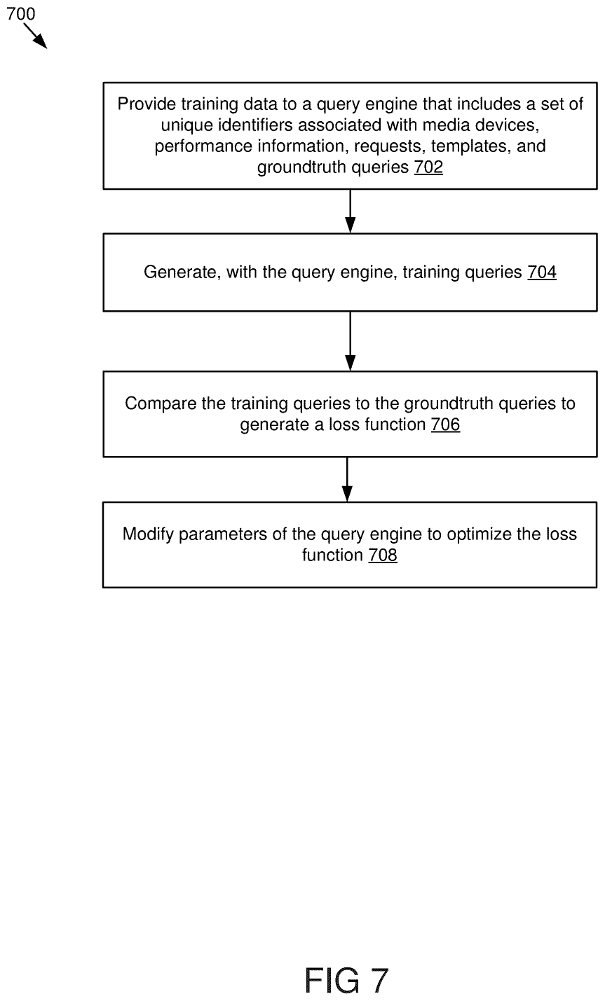

FIG. 7 is a flowchart of an example method 700 to train a machine-learning model to provide recommendations according to some embodiments described herein. The method 700 is implemented by one or more computing devices 200 as described with reference to FIG. 2. The one or more computing devices 200 include the auditory device 135, the mobile device 117, and/or the server 101 as illustrated in FIG. 1.

The method 700 may start with block 702. At block 702, training data is provided to a query engine that includes a set of unique identifiers associated with media devices, performance information, requests, templates, and groundtruth queries. The performance information may be used for groundtruth queries associated with troubleshooting requests or requests for information and not for installation requests. Block 702 may be followed by block 704.

At block 704, the query engine generates training queries. For example, the training queries are generated by inserting the unique identifiers, the requests, and optionally the performance information into templates. Block 704 may be followed by block 706.

At block 706, the training queries are compared to the groundtruth queries to generate a loss function. Block 706 may be followed by block 708.

At block 708, parameters of the query engine are modified to optimize the loss function.

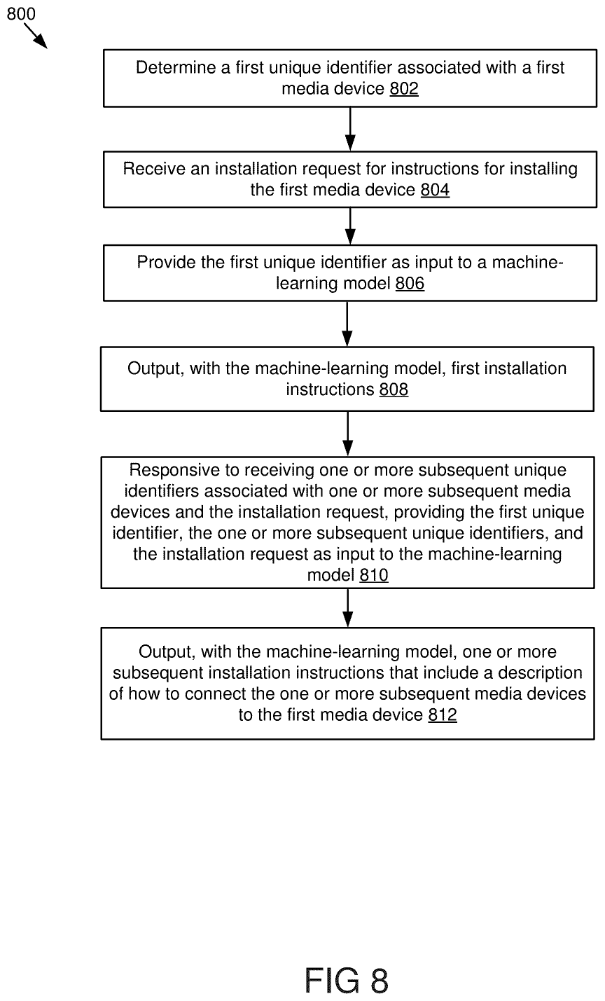

FIG. 8 is a flowchart of an example method to use a machine-learning model to provide installation instructions. The method 800 is implemented by one or more computing devices 200 as described with reference to FIG. 2. The one or more computing devices 200 include the auditory device 135, the mobile device 117, and/or the server 101 as illustrated in FIG. 1.

The method 800 may begin with block 802. At block 802 a first unique identifier associated with a first media device is determined. Block 802 may be followed by block 804.

At block 804, an installation request for instructions for installing the first media device is received. Block 804 may be followed by block 806.

At block 806, the first unique identifier is provided as input to a machine-learning model. Block 806 may be followed by block 808.

At block 808, the machine-learning model outputs first installation instructions. Block 808 may be followed by block 810.

At block 810, responsive to receiving one or more subsequent unique identifiers associated with one or more subsequent media devices and the installation request, providing the first unique identifier, the one or more subsequent unique identifiers, and the installation request as input to the machine-learning model. Block 810 may be followed by block 812.

At block 812, the machine-learning model outputs one or more subsequent installation instructions that include a description of how to connect the one or more subsequent installation instructions to the first media device.

Although the description has been described with respect to particular embodiments thereof, these particular embodiments are merely illustrative, and not restrictive.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. Examples of processing systems can include servers, clients, end mobile devices, routers, switches, networked storage, etc. A computer may be any processor in communication with a memory. The memory may be any suitable processor-readable storage medium, such as random-access memory (RAM), read-only memory (ROM), magnetic or optical disk, or other non-transitory media suitable for storing instructions for execution by the processor.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A computer-implemented method comprises:
determining a first unique identifier associated with a first media device in a media system;
receiving an installation request for instructions for installing the first media device;
providing the first unique identifier as input to a machine-learning model;
outputting, with the machine-learning model, first installation instructions;
responsive to receiving one or more subsequent unique identifiers associated with one or more subsequent media devices in the media system, providing the first unique identifier, the one or more subsequent unique identifiers, and the installation request as input to a machine-learning model; and
outputting, with the machine-learning model, one or more subsequent installation instructions that include a description of how to connect the one or more subsequent media devices to the first media device.

2. The method of claim 1, wherein the machine-learning model includes a query engine and a large language model, the method further comprising:
providing the first unique identifier, the one or more subsequent unique identifiers, and the installation request to the query engine;
combining the first unique identifier, the one or more subsequent unique identifiers, and the installation request with a template to form a query; and
providing the query as input to the large language model, wherein the large language model outputs the first installation instructions that correspond to the query.

3. The method of claim 2, wherein combining the first unique identifier, the one or more subsequent unique identifiers, and the installation request with the template further includes specifying a prioritization of one or more data sources that are used by the large language model to output the installation instructions.

4. The method of claim 1, further comprising:
monitoring the media system to identify information about a performance of the media system;
providing the first unique identifier, the one or more subsequent unique identifiers, and information about the performance of the media system to the machine-learning model as input; and
outputting, with the machine-learning model, an identification of a performance issue associated with the media system and a description of a solution to the performance issue.

5. The method of claim 4, wherein the performance issue is associated with the first media device, the method further comprising:
determining that the solution to the performance issue fails; and
contacting a chatbot associated with a manufacturer of the first media device to obtain an additional solution.

6. The method of claim 1, further comprising:
receiving a request for information about the first media device;
providing first unique identifier, the request for information, and information about the performance of the media system to the machine-learning model; and
outputting, with the machine-learning model, the information about the first media device.

7. The method of claim 1, further comprising:
receiving feedback about whether the first installation instructions were successful; and
providing the feedback to the machine-learning model.

8. The method of claim 7, wherein the feedback is selected from a group of a confirmation from a user that the first installation instructions worked, an inference that the first installation instructions worked based on the first media device connecting to a network, and combinations thereof.

9. The method of claim 1, wherein outputting the first installation instructions includes generating a diagram of the first media device and the one or more subsequent media devices in the media system.

10. The method of claim 1, wherein determining the first unique identifier associated with the first media device is based on one action selected from a group of: scanning a barcode or a QR code, receiving a Request For Information (RFI), receiving a Near Field Communication (NFC), receiving a manufacturer name and a model number, scanning a page that includes purchasing information, receiving the first unique identifier from a mobile device, and combinations thereof.

11. A system comprising:
one or more processors; and
logic encoded in one or more non-transitory media for execution by the one or more processors and when executed are operable to:
determine a first unique identifier associated with a first media device in a media system;
receive an installation request for instructions for installing the first media device;
provide the first unique identifier as input to a machine-learning model;
output, with the machine-learning model, first installation instructions;
responsive to receiving one or more subsequent unique identifiers associated with one or more subsequent media devices in the media system, provide the first unique identifier, the one or more subsequent unique identifiers, and the installation request as input to a machine-learning model; and
output, with the machine-learning model, one or more subsequent installation instructions that include a description of how to connect the one or more subsequent media devices to the first media device.

12. The system of claim 11, wherein the machine-learning model includes a query engine and a large language model and the logic is further operable to:
provide the first unique identifier, the one or more subsequent unique identifiers, and the installation request to the query engine;
combine the first unique identifier, the one or more subsequent unique identifiers, and the installation request with a template to form a query; and
provide the query as input to the large language model, wherein the large language model outputs the first installation instructions that correspond to the query.

13. The system of claim 12, wherein combining the first unique identifier, the one or more subsequent unique identifiers, and the installation request with the template further includes specifying a prioritization of one or more data sources that are used by the large language model to output the installation instructions.

14. The system of claim 11, wherein the logic is further operable to:
monitor the media system to identify information about a performance of the media system;
provide the first unique identifier, the one or more subsequent unique identifiers, and information about the performance of the media system to the machine-learning model as input; and
output, with the machine-learning model, an identification of a performance issue associated with the media system and a description of a solution to the performance issue.

15. The system of claim 14, wherein the performance issue is associated with the first media device and the software is further operable to:
determine that the solution to the performance issue fails; and
contact a chatbot associated with a manufacturer of the first media device to obtain an additional solution.

16. Software encoded in one or more non-transitory computer-readable media for execution by one or more processors and when executed is operable to:
determine a first unique identifier associated with a first media device in a media system;
receive an installation request for instructions for installing the first media device;
provide the first unique identifier as input to a machine-learning model;
output, with the machine-learning model, first installation instructions;
responsive to receiving one or more subsequent unique identifiers associated with one or more subsequent media devices in the media system, provide the first unique identifier, the one or more subsequent unique identifiers, and the installation request as input to a machine-learning model; and
output, with the machine-learning model, one or more subsequent installation instructions that include a description of how to connect the one or more subsequent media devices to the first media device.

17. The software of claim 16, wherein the machine-learning model includes a query engine and a large language model and the software is further operable to:
provide the first unique identifier, the one or more subsequent unique identifiers, and the installation request to the query engine;
combine the first unique identifier, the one or more subsequent unique identifiers, and the installation request with a template to form a query; and
provide the query as input to the large language model, wherein the large language model outputs the first installation instructions that correspond to the query.

18. The software of claim 17, wherein combining the first unique identifier, the one or more subsequent unique identifiers, and the installation request with the template further includes specifying a prioritization of one or more data sources that are used by the large language model to output the installation instructions.

19. The software of claim 16, wherein the software is further operable to:
monitor the media system to identify information about a performance of the media system;
provide the first unique identifier, the one or more subsequent unique identifiers, and information about the performance of the media system to the machine-learning model as input; and
output, with the machine-learning model, an identification of a performance issue associated with the media system and a description of a solution to the performance issue.

20. The software of claim 19, wherein the performance issue is associated with the first media device and the software is further operable to:
determine that the solution to the performance issue fails; and
contact a chatbot associated with a manufacturer of the first media device to obtain an additional solution.
